(19) United States
(12) Patent Application Publication
(10) Pub. No.: US 2023/0039314 A1
(43) Pub. Date: Feb. 9, 2023

(54) FINGERPRINT IDENTIFICATION DEVICE AND FINGERPRINT IDENTIFICATION METHOD

(71) Applicant: Egis Technology Inc., Hsinchu City (TW)

(72) Inventors: Chen Yang, Hsinchu City (TW); Kuan-Yi Lin, Hsinchu City (TW); Chia-Wei Lin, Hsinchu City (TW); Yu-Hua Lin, Hsinchu City (TW)

(73) Assignee: Egis Technology Inc., Hsinchu City (TW)

(21) Appl. No.: 17/790,135

(22) PCT Filed: Jun. 15, 2020
(86) PCT No.: PCT/CN2020/096090

§ 371 Date: Jun. 30, 2022

Related U.S. Application Data
(60) Provisional application No. 62/963,546, filed on Jan. 21, 2020.

(51) Int. Cl. G06V 40/13; G06V 40/12; G06V 40/40

(52) U.S. Cl. CPC G06V 40/1318; G06V 40/1365; G06V 40/40

(57) ABSTRACT

The invention provides a fingerprint identification device and a fingerprint identification method. The fingerprint identification device includes: a display; a light source disposed below the display; a sensor disposed below the display; and a processing module coupled to the sensor. When an object contacts the display, the light source emits structured light to scan the object. The sensor obtains one or more images of the object, and the one or more images include information of different phase displacements. The processing module is used for calculating three-dimensional information of the object according to the one or more images and judging whether the object is a real finger or not according to the three-dimensional information.

### BACKGROUND

### Technology Field

The invention relates to a fingerprint identification device and a fingerprint identification method, and particularly, to a fingerprint identification device and a fingerprint identification method capable of identifying whether a finger image is a real human finger.

### Description of Related Art

As the technology advances, fingerprint identification has become one of the main methods for identity verification. When fingerprint grease is left on the fingerprint sensor, an object other than fingers to press on the fingerprint sensor may result in misjudgment of the residual fingerprint, leading to a decrease in the accuracy and security of fingerprint identification. Therefore, how to identify whether there is a real human finger on the fingerprint sensor in a more accurate manner is what those skilled in the art dedicate themselves to.

### SUMMARY

In view of this, the invention provides a fingerprint identification device and a fingerprint identification method capable of identifying whether a finger image is a real human finger.

The invention provides a fingerprint identification device, including a display; a light source disposed below the display; a sensor disposed below the display; and a processing module coupled to the sensor. The light source emits structured light to scan an object when the object is in contact with the display. The sensor obtains one or more images of the object, and the one or more images include information of different phase displacements. The processing module calculates three-dimensional information of the object according to the one or more images and determines whether the object is a real human finger or not according to the three-dimensional information.

The invention provides a fingerprint identification method, adapted for a fingerprint identification device. The fingerprint identification device includes a display, and a light source and a sensor disposed below the display. The fingerprint identification method includes steps as follows. The light source emits structured light to scan an object when the object is in contact with the display. One or more images of the object is obtained through the sensor, the one or more images include information of different phase displacements, three-dimensional information of the object is calculated according to the one or more images, and whether the object is a real human finger or not is determined according to the three-dimensional information.

In summary, in the fingerprint identification device and fingerprint identification method of the invention, the light source emits structured light to scan the object in contact with the display, and the sensor obtains one or more images of the object scanned by the structured light. The processing module calculates the three-dimensional information of the object according to the one or more images, and whether the object is a real human finger or not is determined according to the three-dimensional information. Accordingly, the fingerprint identification device and the fingerprint identification method of the invention achieve the anti-counterfeiting effect by determining whether the object to be sensed is a real three-dimensional fingerprint, and the problem of identification errors resulting from residual fingerprints is solved.

In order to make the features and advantages of the invention comprehensible, embodiments accompanied with drawings are described in detail below.

### BRIEF DESCRIPTION OF THE DRAWING

The accompanying drawings are included to provide a further understanding of the invention, and are incorporated in and constitute a part of this specification. The drawings illustrate embodiments of the invention and together with the description serve to explain the principles of the invention.

FIG. 1A and FIG. 1B are schematic views of a fingerprint identification device according to an embodiment of the invention.

FIG. 2 is a schematic view of a structured light pattern emitted by a display corresponding to a position of a sensor according to an embodiment of the invention.

FIG. 3 is a schematic view of a structured light pattern emitted by a display corresponding to a position of a sensor according to an embodiment of the invention.

FIG. 4 is a flowchart of a fingerprint identification method according to an embodiment of the invention.

### DESCRIPTION OF REFERENCE NUMERALS

100: fingerprint identification device

110: display

115: light source

120: sensor

130: processing module

220: region

230(1)-230(N): phase pattern

320: region

331: red phase pattern

332: green phase pattern

333: blue phase pattern

S401-S403: steps of the fingerprint identification method

### DESCRIPTION OF THE EMBODIMENTS

Reference will now be made in detail to the exemplary embodiments of the invention, examples of which are illustrated in the accompanying drawings. Whenever possible, the same reference numerals are used to represent the same or similar parts in the accompanying drawings and description.

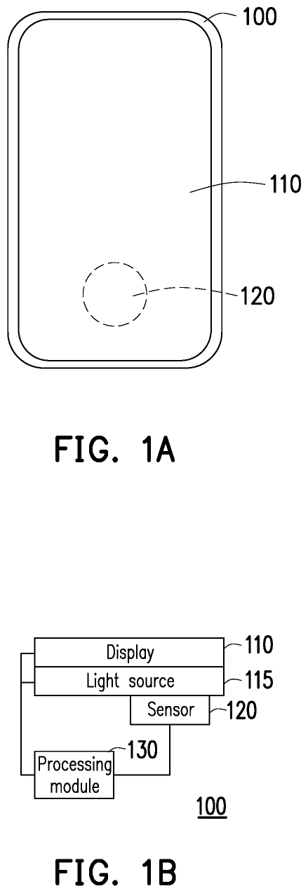

FIG. 1A and FIG. 1B are schematic views of a fingerprint identification device according to an embodiment of the invention.

Referring to FIG. 1A and FIG. 1B, according to an embodiment of the invention, a fingerprint identification device 100 includes a display 110, a light source 115, a sensor 120, and a processing module 130. The light source 115 is disposed below the display 110. The sensor 120 is disposed below the display 110. The processing module 130 is coupled to the display 110, the light source 115, and the sensor 120. The display 110 is an organic light emitting diode (OLED) display, a liquid crystal display (LCD), or other similar components, for example. In one embodiment, the display 110 may integrate touch sensing components therein. The invention does not limit the implementation of the light source 115. Specifically, when the display 110 is an OLED display, the light source 115 can be a self-luminous display component and integrated below the display 110. When the display 110 is an LCD, the light source 115 may be an external lighting component. The light source 115 is overlapped with the sensor 120, as shown in FIG. 1B, but the invention is not limited thereto. In some embodiments, the light source 115 may also be disposed on one or two sides below the display 110 and not overlapped with the sensor 120 or only partially overlapped with the sensor 120.

The sensor 120 is a thin film transistor (TFT) sensor or other similar components, for example. The circular shape of the sensor 120 and the position of the sensor 120 on the fingerprint identification device 100 are only for illustration, and the invention does not limit the shape of the sensor 120 and the position of the sensor 120 on the fingerprint identification device 100. The processing module 130 is a central processing unit (CPU), an application processor (AP), or other programmable general-purpose or special-purpose microprocessor, a digital signal processor (DSP), a programmable controller, an application specific integrated circuit (ASIC), a programmable logic device (PLD), or a combination thereof, for example.

### Embodiment One

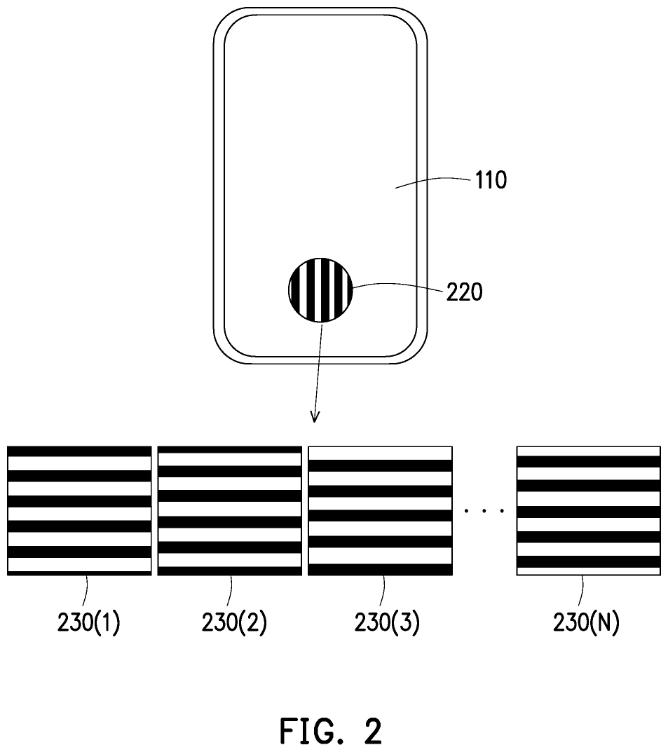

FIG. 2 is a schematic view of a structured light pattern emitted by a display corresponding to a position of a sensor according to an embodiment of the invention.

Referring to FIG. 1A, FIG. 1B, and FIG. 2 altogether, when an object to be sensed is in contact with a region 220 of the display 110 corresponding to the sensor 120, the light source 115 can emit structured light to scan the object to be sensed. The structured light may have phase patterns 230(1), 230(2), 230(3), . . . , 230(N) with different phase displacements, and the light source 115 sequentially emits structured light with the phase patterns 230(1)-230(N) to scan the object to be sensed, so that the sensor 120 obtains N images of the object to be sensed corresponding to the phase patterns 230(1)-230(N). The phase patterns 230(1)-230(N) may be created by sinusoidal fringe patterns, and each of the phase patterns 230(1)-230(N) may include information of different phase displacements. Taking N=3 as an example, the phase pattern 230(1) and the phase pattern 230(2) can correspond to a phase displacement of 360/3=120 degrees, and the phase pattern 230(2) and the phase pattern 230(3) can correspond to a phase displacement of 120 degrees.

Next, the processing module 130 can obtain N images of the object to be sensed from the sensor 120. The three-dimensional information (or called the three-dimensional topography of the object to be sensed) of the object to be sensed is calculated by the phase algorithm according to the N images of the object to be sensed, and whether the object to be sensed is a real human finger is determined according to the three-dimensional information. After the processing module 130 determines that the object to be sensed is a real human finger, the processing module 130 performs a fingerprint identification operation on the real human finger. If the processing module 130 determines that the object to be sensed is not a real human finger, the processing module 130 does not perform a fingerprint identification operation on the real human finger. Accordingly, when an object other than fingers is pressed above the sensor 120, the problem of misjudging the residue of fingerprint grease can be solved.

The phase algorithm is expressed in equation (1) to equation (4) as follows.

$${I}_{1} ( x , y ) = {I}^{′} ( x , y ) + {I}^{″} ( x , y ) cos [ ϕ ( x , y ) - α ] , \qquad ( 1 )$$

$${I}_{2} ( x , y ) = {I}^{′} ( x , y ) + {I}^{″} ( x , y ) cos [ ϕ ( x , y ) ] , \qquad ( 2 )$$

$${I}_{3} ( x , y ) = {I}^{′} ( x , y ) + {I}^{″} ( x , y ) cos [ ϕ ( x , y ) + α ] , \qquad ( 3 )$$

$$ϕ ( x , y ) = arctan ( \sqrt{3} \frac{{I}_{1} - {I}_{3}}{2 {I}_{2} - {I}_{1} - {I}_{3}} ) . \qquad ( 4 )$$

I is the pixel exposure value intensity in the image, I′ is the corresponding basic light intensity (e.g., ambient light intensity), I″ is the structured light intensity projected by the corresponding light source 115, Φ is the phase angle, and a is the phase displacement. Equation (4) can be derived by eliminating I′, I″, and α from equation (1) to equation (3).

### Embodiment Two

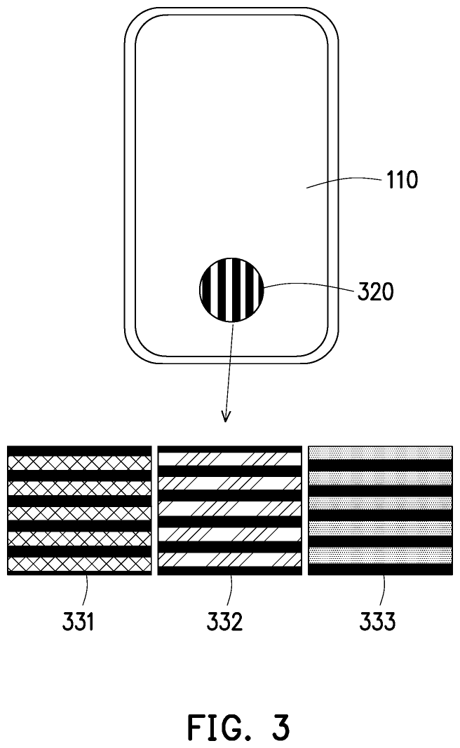

FIG. 3 is a schematic view of a structured light pattern emitted by a display corresponding to a position of a sensor according to an embodiment of the invention.

Referring to FIG. 1A, FIG. 1B, and FIG. 3 altogether, when the object to be sensed is in contact with a region 320 of the display 110 corresponding to the sensor 120, the light source 115 can emit structured light with a color pattern to scan the object to be sensed so that the sensor 120 can obtain a color image of the object to be sensed. The color pattern of the structured light can be a three-channel color image formed by a red phase pattern 331, a green phase pattern 332, and a blue phase pattern 333. For example, the red phase pattern 331, the green phase pattern 332, and the blue phase pattern 333 may have a phase displacement of 120 degrees among one another.

Next, the processing module 130 can obtain the color image of the object to be sensed from the sensor 120, and the color image of the object to be sensed is separated to obtain a first image corresponding to the red phase pattern 331, a second image corresponding to the green phase pattern 332, and a third image corresponding to the blue phase pattern 333. Finally, the processing module 130 calculate the three-dimensional information of the object to be sensed by the phase algorithm similar to that in equation (1) to equation (4) according to the first image, the second image, and the third image, and whether the object to be sensed is a real human finger is determined according to the three-dimensional information. In the embodiment, three phase images of the object to be sensed, the first image corresponding to the red phase pattern 331, the second image corresponding to the green phase pattern 332, and the third image corresponding to the blue phase pattern 333 of the object to be sensed, can be obtained through a single structured light color pattern including three-channel color images, so the time spent in scanning the object to be sensed by emitting the structured light phase pattern for multiple times can be saved.

Note that to obtain a color image of the object to be sensed, the sensor 120 may be a color sensor. In one embodiment, the sensor 120 may be a single sensor with a color filter (or called a color resist) disposed thereon. In another embodiment, the sensor 120 may be composed of three sensors corresponding to red, green, and blue. The invention does not limit the implementation of the sensor 120.

Referring to FIG. 2 again, the distance each time the sinusoidal fringes in the adjacent phase patterns 230(1)-230(N) move is 1/N of the period, so scanning the object to be sensed with the structured light with the phase patterns 230(1)-230(N) can also be called the N-step phase shift method. In the phase shift method with more than three steps, the method in the second embodiment of the invention can be used to reduce the number of times of image acquisitions of the sensor 120 and thus time is saved. For example, in a 6-step phase shift method with N=6, the phase patterns 230(1)-230(3) can be mixed into a three-channel color phase pattern, and the phase patterns 230(4)-230(6) can be mixed into another three-channel color phase pattern, where the phase patterns 230(1) and 230(4) are red phase patterns, the phase patterns 230(2) and 230(5) are green phase patterns, and the phase patterns 230(3) and 230(6)) are blue phase patterns. Therefore, the light source 115 only needs to emit structured light with two color phase patterns, that is, the structured light with one color phase pattern corresponding to the phase patterns 230(1)-230(3) and the other color phase pattern corresponding to the phase patterns 230(4)-230(6), and six images corresponding to the phase patterns 230(1)-230(6) of the object to be sensed can be obtained.

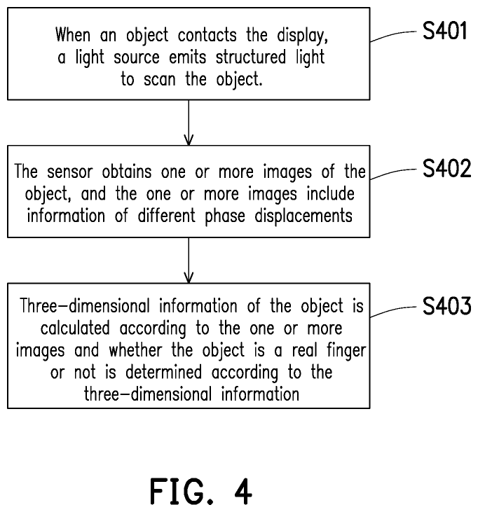

FIG. 4 is a flowchart of a fingerprint identification method according to an embodiment of the invention.

Referring to FIG. 4, in step S401, when the object is in contact with the display, the light source emits structured light to scan the object.

In step S402, the sensor obtains one or more images of the object, and the one or more images include information of different phase displacements.

In step S403, the three-dimensional information of the object is calculated according to one or more images, and whether the object is a real human finger or not is determined according to the three-dimensional information.

In summary, in the fingerprint identification device and fingerprint identification method of the invention, the light source emits structured light to scan the object in contact with the display, and the sensor obtains one or more images of the object scanned by the structured light. The processing module calculates the three-dimensional information of the object according to the one or more images, and whether the object is a real human finger or not is determined according to the three-dimensional information. Accordingly, the fingerprint identification device and the fingerprint identification method of the invention achieve the anti-counterfeiting effect by determining whether the object to be sensed is a real three-dimensional fingerprint, and the problem of identification errors resulting from residual fingerprints is solved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A fingerprint identification device, comprising:
a display;
a light source disposed below the display and emitting structured light to scan an object when the object is in contact with the display;
a sensor disposed below the display and obtaining one or more images of the object, wherein the one or more images comprise information of different phase displacements; and
a processing module coupled to the sensor, calculating three-dimensional information of the object according to the one or more images, and determining whether the object is a real human finger or not according to the three-dimensional information.

2. The fingerprint identification device according to claim 1, wherein the structured light comprises a plurality of phase patterns with different phase displacements, and the light source sequentially emits the structured light with the plurality of phase patterns to scan the object, so that the sensor obtains the images of the object.

3. The fingerprint identification device according to claim 1, wherein the structured light comprises a color pattern, the color pattern is composed of a red phase pattern, a green phase pattern, and a blue phase pattern with different phase displacements, and the light source emits the structured light with the color pattern to scan the object, so that the sensor obtains the image of the object.

4. The fingerprint identification device according to claim 3, wherein the image of the object is a color image, the processing module separates the image to obtain a first image corresponding to the red phase pattern, a second image corresponding to the green phase pattern, and a third image corresponding to the blue phase pattern, and the three-dimensional information of the object is calculated according to the first image, the second image, and the third image.

5. The fingerprint identification device according to claim 1, wherein the display is an organic light emitting diode display.

6. A fingerprint identification method, adapted for a fingerprint identification device, wherein the fingerprint identification device comprises a display and a light source and a sensor disposed below the display, and the fingerprint identification method comprises:
the light source emits structured light to scan an object when the object is in contact with the display;
obtaining one or more images of the object through the sensor, wherein the one or more images comprise information of different phase displacements; and
calculating three-dimensional information of the object according to the one or more images, and determining whether the object is a real human finger or not according to the three-dimensional information.

7. The fingerprint identification method according to claim 6, wherein the structured light comprises a plurality of phase patterns with different phase displacements, and the light source sequentially emits the structured light with the plurality of phase patterns to scan the object so that the sensor obtains the images of the object.

8. The fingerprint identification method according to claim 6, wherein the structured light comprises a color pattern, the color pattern is composed of a red phase pattern, a green phase pattern, and a blue phase pattern with different phase displacements, and the light source emits the structured light with the color pattern to scan the object, so that the sensor obtains the image of the object.

9. The fingerprint identification method according to claim 8, wherein the image of the object is a color image, and the step of calculating the three-dimensional information of the object according to the one or more images comprises separating the image to obtain a first image corresponding to the red phase pattern, a second image corresponding to the green phase pattern, and a third image corresponding to the blue phase pattern, and calculating the three-dimensional information of the object according to the first image, the second image, and the third image.

10. The fingerprint identification method according to claim 6, wherein the display is an organic light emitting diode display.
